(19) United States
(12) Patent Application Publication
(10) Pub. No.: US 2008/0065581 A1
(43) Pub. Date: Mar. 13, 2008

(54) Method, System, and Program Product for Shell Executable Search Path Optimization

(76) Inventors: Susann M. Keohane, Austin, TX (US); Gerald F. McBrearty, Austin, TX (US); Shawn P. Mullen, Buda, TX (US); Jessica Murillo, Round Rock, TX (US); Johnny Meng-Han Shieh, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/467,613

(22) Filed: Aug. 28, 2006

(51) Int. Cl. G06F 17/30

(52) U.S. Cl. 707/1

(57) ABSTRACT

A method of data processing in a data processing system includes an operating system shell receiving a command identifying a target executable. In response to receiving the command, the operating system shell determines whether or not a directory re-order option is set. In response to determining that the directory re-order option is set, the operating system shell locates the target executable by searching one or more file system directories for the target binary executable in accordance with an order indicated by a set of dynamic weights associated with directories among said one or more file system directories. The set of dynamic weights is then updated based upon the determined location of the target executable in the file system.

### BACKGROUND OF THE INVENTION

1. Technical Field

The present invention relates in general to the field of computers and other data processing systems, and in particular to scripting languages. Still more particularly, the present invention pertains to utilizing scripting languages to efficiently search for executable files within a directory tree data structure.

2. Description of the Related Art

Different computer programming languages exist for varying purposes and are suited to different styles of programming. Scripting languages (also referred to as batch languages) are computer programming languages created to shorten the conventional programming process. Since a script is typically interpreted rather than compiled, a script is usually faster to compose, and script files are typically much smaller than equivalent high-level programming language files. An operating system usually offers some type of scripting language by default, also known as a shell script language. Conventional shell script languages include Bourne shell (bsh), Korn shell (ksh), and C shell (csh).

Each of these shells is capable of searching for executables or data within a file system or directory. File systems are typically structured as a tree of interconnected nodes in order to facilitate efficient access to the data located at a particular node, where the nodes are implemented as storage devices, such as a hard disks or CD-ROMs, which may be local to or remote from the host. Tree traversal, which is the process of visiting each node in a tree data structure, allows sequential processing of each node in a tree data structure. Such traversals typically involve numerous nodes and consequently occupy large amounts of processing time.

A conventional in-order traversal visits each node of a tree data structure between the nodes in the left-most sub-tree and the nodes in the right-most sub-tree. However, conventional in-order traversal may consume excessive amounts of processor time in cases where an intermediate node is down or operating very slowly with respect to other nodes in the tree. For example, if a user prompts a shell, such as ksh, to search for executables in a tree data structure, then each directory in the corresponding tree data structure will be searched in order, regardless of whether the user frequently accesses executables located in a specific directory. In order to avoid a slow or failed directory in the tree, the user could remove the slow or failed directory from the directory tree or manually reset the search path to bypass the slow or failed directory. Removing the slow or failed directory would necessitate that the user replace the directory at a later time, and manually resetting the search path is inefficient for multiple searches.

The present invention thus recognizes that an improved method and system for enabling a shell to automatically optimize search paths within a directory tree is needed.

### SUMMARY OF THE INVENTION

Disclosed are a method, system, and computer program product for enabling an operating system shell to automatically optimize search paths within a directory tree data structure.

A method of data processing in a data processing system includes an operating system shell receiving a command identifying a target executable. In response to receiving the command, the operating system shell determines whether or not a directory re-order option is set. In response to determining that the directory re-order option is set, the operating system shell locates the target executable by searching one or more file system directories for the target binary executable in accordance with an order indicated by a set of dynamic weights associated with directories among said one or more file system directories. The set of dynamic weights is then updated based upon the determined location of the target executable in the file system.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 depicts a high level block diagram of an exemplary data processing system, as utilized in an embodiment of the present invention;

FIG. 2 illustrates a high level block diagram of an exemplary directory tree data structure, as utilized in an embodiment of the present invention; and

FIG. 3 is a high level logical flowchart of an exemplary method of directory searching in accordance with one embodiment of the invention.

### DETAILED DESCRIPTION OF AN ILLUSTRATIVE EMBODIMENT

The present invention provides a method, system, and computer program product for enabling a shell to automatically optimize search paths within a directory tree data structure.

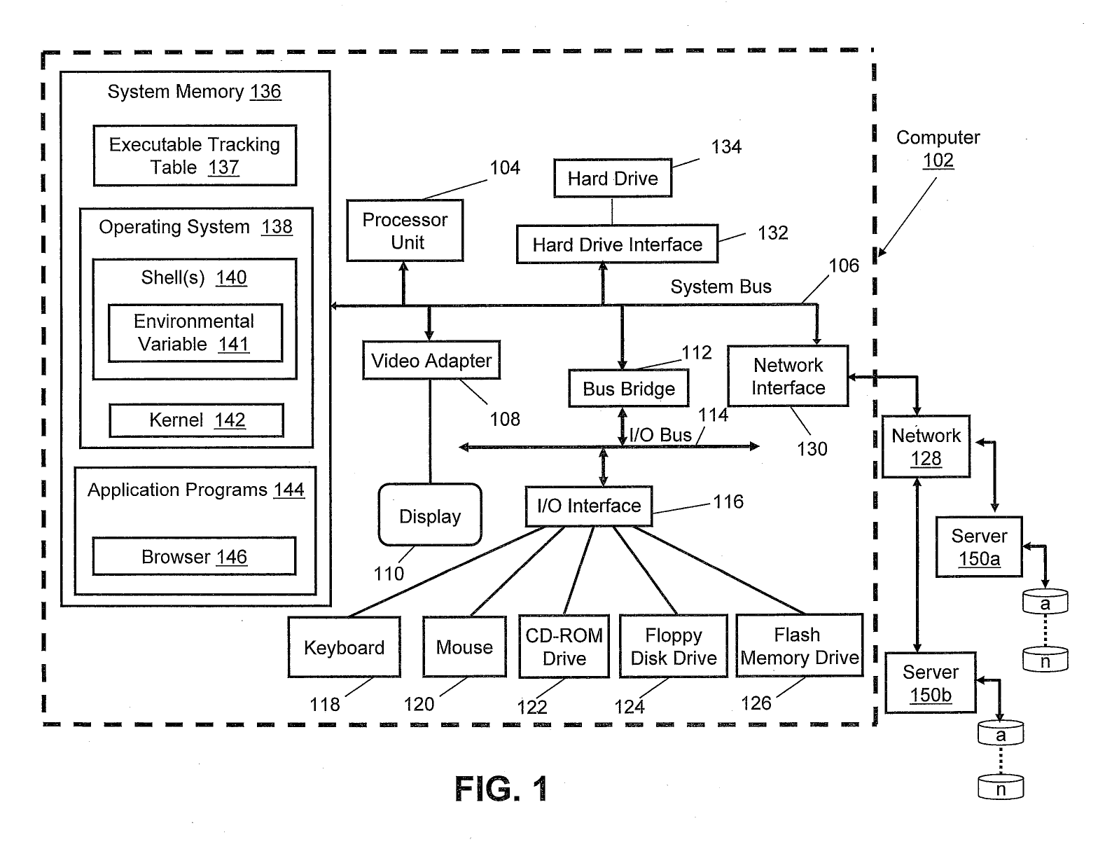

With reference now to FIG. 1, there is depicted a block diagram of an exemplary computer 102, with which the present invention may be utilized. Computer 102 includes processor unit 104 that is coupled to system bus 106. Video adapter 108, which drives/supports a display 110, is also coupled to system bus 106. System bus 106 is coupled via bus bridge 112 to Input/Output (I/O) bus 114. I/O interface 116 is coupled to I/O bus 114. I/O interface 116 affords communication with various I/O devices, including keyboard 118, mouse 120, Compact Disk-Read Only Memory (CD-ROM) drive 122, floppy disk drive 124, and flash drive memory 126. The format of the ports connected to I/O interface 116 may be any known to those skilled in the art of computer architecture, including but not limited to Universal Serial Bus (USB) ports.

Computer 102 is able to communicate with servers 150a and 150b via network 128 using network interface 130, which is coupled to system bus 106. Servers 150a and 150b include a plurality of directories, each of which may contain data organized as a tree data structure. Network 128 may be an external network such as the Internet, or an internal network such as an Ethernet or a Virtual Private Network (VPN).

Hard drive interface 132 is also coupled to system bus 106. Hard drive interface 132 interfaces with a hard drive 134. In a preferred embodiment, hard drive 134 populates a system memory 136, which is also coupled to system bus 106. Data that populates system memory 136 includes executable tracking table 137, operating system (OS) 138, and application programs 144.

OS 138 includes shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

Shell 140 may support one or more shell scripting languages, including, without limitation, Korn Shell (ksh), Bourne Shell (bsh), and C Shell (csh). As depicted, shell 140 also includes environmental variable 141, which may be utilized by the user of computer 102 to enable or disable the search path optimization in accordance with the present invention. OS 138 also includes kernel 142, which includes lower levels of functionality for OS 138, including providing essential services required by other parts of OS 138 and application programs 144, including memory management, process and task management, file system management, and mouse and keyboard management.

Application programs 144 include browser 146. Browser 146 includes program modules and instructions enabling a World Wide Web (WWW) client (i.e., client computer 102) to send and receive network messages to the Internet using HyperText Transfer Protocol (HTTP) messaging.

The hardware elements depicted in computer 102 are not intended to be exhaustive, but rather are representative to highlight certain components that mat be utilized to practice the present invention. For instance, computer 102 may include alternate memory storage devices such as magnetic cassettes, Digital Versatile Disks (DVDs), Bernoulli cartridges, and the like. These and other variations are intended to be within the spirit and scope of the present invention.

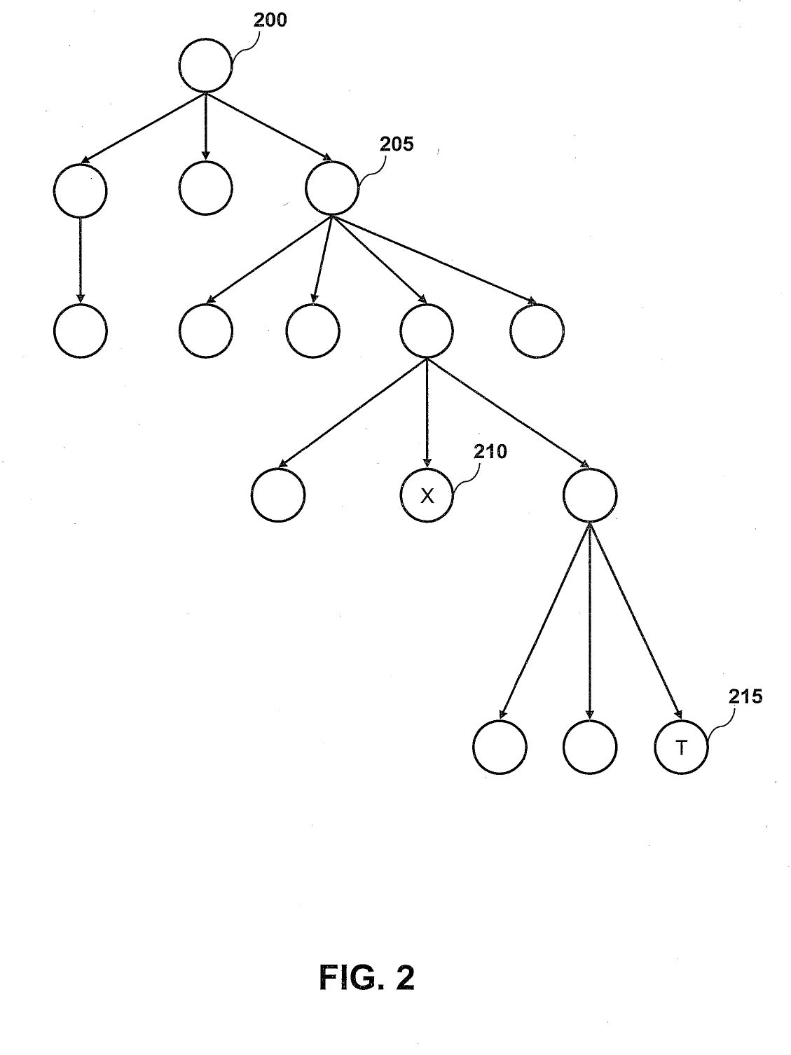

With reference now to FIG. 2, there is depicted a high level block diagram of a directory tree data structure of a file system accessible to OS 138, as utilized in an embodiment of the present invention. The directory tree data structure comprises parent (root) node 200 linked to a plurality of child nodes, such as node 205, where each node represents a resource or a container for one or more resources. The directory tree may be further divided into a plurality of branches. A branch is defined as all interconnected sub-nodes of an immediate child node of parent node 200. As shown in FIG. 2, the branch beginning at node 205 comprises ten nodes below the third child node of parent node 200. The directory tree data structure of FIG. 2 also includes target (T) node 215 and slow or down node 210, where a slow node is defined as a node experiencing a higher than normal access latency (e.g. due to the operation of contemporaneous processes or intermittent network connectivity) and a down node is defined as a node experiencing an operating error (e.g. due to a hardware malfunction or corrupted data file).

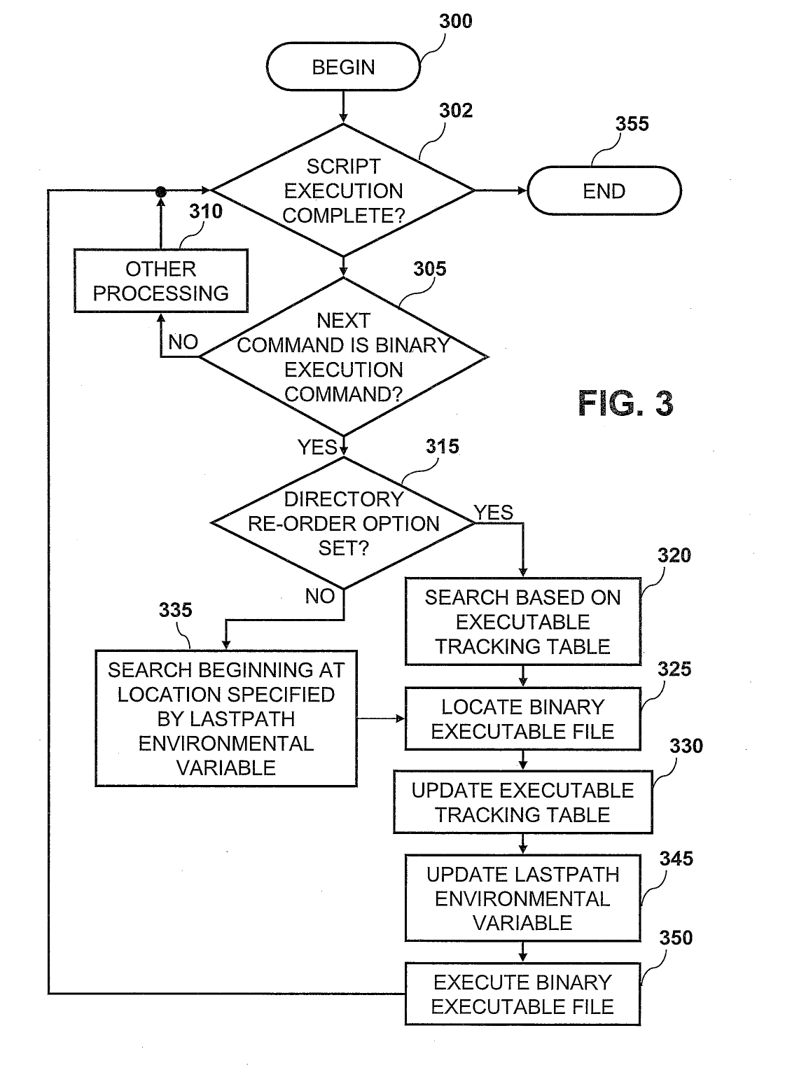

As illustrated in FIG. 2, slow/down node 210 is located in the branch beginning at node 205 and may be in the search path leading to target node 215. Conventional search methods that utilize an in-order tree traversal while attempting to locate target node 215 may therefore encounter delays or experience errors upon reaching slow/down node 210. The present invention thus provides a method and system for locating target node 215 without first accessing slow/down node 210, as illustrated in FIG. 3 and described in detail below.

Turning now to FIG. 3, there is depicted a high level logical flowchart of an exemplary method of directory searching in accordance with one embodiment of the invention. The directory search process begins at block 300, for example, in response to a user of computer 102 invoking execution of a shell script by shell 140, which preferably performs the remainder of the illustrated steps in an automated manner. The depicted method may alternatively be performed by a shell instance run by a script under execution.

Shell 140 first determines at block 302 whether or not execution of the shell script is complete. If so, the process terminates at block 355. If, however, execution of the shell script is not complete, shell 140 determines at block 305 whether or not the next command of the shell script is a binary execution command. If not, shell 140 invokes other appropriate processing, as depicted at block 310. If, however, the next command of the shell script is a binary execution command, shell 140 initiates a search to locate the specified executable. As will be appreciated, the target executable file may reside anywhere within the file system, including within servers 150a and 150b or within system memory 136, CD-ROM drive 122, floppy disk drive 124, flash memory drive 126, or hard drive 134 of client computer 102.

Prior to searching for the target binary executable, shell 140 determines at block 315 whether a directory re-order option is set within shell 140, for example, by the user setting an environmental variable 141 such as PATHSEARCH. As depicted at block 320, if the user of computer 102 has set (i.e., asserted) the directory re-order option within shell 140, then shell 140 searches the directories in a descending order based on the total number of binary executable files previously found in each directory during a search for a binary executable. Information used to determine the total number of files previously found in each directory is collected during searches and stored in executable tracking table 137 in system memory 136. At block 325, the directory search performed by shell 140 eventually locates target node 215, which contains the executable file corresponding to the binary execution command. At block 330, shell 140 updates execution tracking table 137 to update the number of executables found within the directory that contains the binary executable in node 215. Consequently, each directory on the path has a “weight” or count recorded within executable tracking table 137 based on the number of executions from that directory which will then affect the directory order employed in the next search for an executable.

Following block 330, shell 140 updates a second environmental variable such as LASTPATH at block 345 to identify the directory containing the target binary executable that was obtained as a result of the search operation. Shell 140 then invokes the execution of the binary executable file that was found by the search at target node 215 (block 350). Thereafter, the process returns to block 302, which has been described.

Returning to block 315, if environmental variable 141, such as PATHSEARCH, is not set to re-order the directory search in order of the most populous directories of binary executables, shell 140 initiates a search for the target binary executable beginning with the last directory identified by the environmental variable LASTPATH. Thus, rather than performing a strictly in-order tree traversal as is conventional, shell 140 initiates the search for target node 215 at a location specified by the LASTPATH environmental variable. If the target binary executable is not located in the directory specified by the LASTPATH environmental variable, the search simply continues utilizing a conventional in-order tree traversal. Following block 305, the process passes to block 325 and following blocks, which have been described.

As has been described, the present invention provides a method, system and program product for optimizing a search for a binary executable by an operating system shell. According to one embodiment of the method, the operating system shell receives a script command identifying a target binary executable to be executed. In response to receiving the script command, the operating system shell determines whether or not a directory re-order option is set. In response to determining that the directory re-order option is set, the operating system shell searches one or more file system directories for the for the target binary executable in accordance with a number of binary executables in the one or more file system directories. In response to locating the target binary executable, the operating system shell invokes execution of the target binary executable.

While the invention has been particularly shown and described with reference to a preferred embodiment, it will be understood by those skilled in the art that various changes in form and detail may be made therein without departing from the spirit and scope of the invention. For example, while an illustrative embodiment of the present invention has been described in the context of a fully functional computer system with installed software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as flash memory drives, floppy disks, hard drives, CD ROMs, DVDs, and transmission type media such as digital and analog communication links.

What is claimed is:

1. A method of data processing in a data processing system, said method comprising:
an operating system shell receiving a command identifying a target executable to be found;
in response to receiving the command, said operating system shell determining whether or not a directory re-order option is set;
in response to determining that said directory re-order option is set, said operating system shell locating the target executable by searching one or more file system directories for said for said target executable in accordance with an order indicated by a set of dynamic weights associated with directories among said one or more file system directories; and
updating the set of dynamic weights based upon the determined location of the target executable in the file system.

2. The method of claim 1, wherein:
said method further comprises recording in a data structure the set of dynamic weights, wherein the set of dynamic weights are based upon a number of executables found in each of a plurality of file system directories that are searched; and
said searching comprising searching said one or more file system directories utilizing an ordering indicated by said data structure.

3. The method of claim 1, and further comprising:
in response to said operating system shell determining that said directory re-order option is not set, said operating system shell searching said one or more file system directories beginning with a file system directory containing a most recently located target executable.

4. The method of claim 3, and further comprising:
recording a file system directory containing said target executable in an environmental variable of said operating system shell.

5. The method of claim 1, wherein said determining comprises determining whether said directory re-order option is set by reference to an environmental variable of said operating system shell.

6. The method of claim 1, and further comprising:
in response to locating said target executable, said operating system shell invoking execution of said target executable.

7. A program product, comprising:
a signal bearing medium;
an operating system shell within said signal bearing medium that causes a data processing system to perform a method including:
receiving a command identifying a target executable to be found;
in response to receiving the command, determining whether or not a directory re-order option is set;
in response to determining that said directory re-order option is set, locating the target executable by searching one or more file system directories for said for said target executable in accordance with an order indicated by a set of dynamic weights associated with directories among said one or more file system directories; and
updating the set of dynamic weights based upon the determined location of the target executable in the file system.

8. The program product of claim 7, wherein:
said method further comprises recording in a data structure the set of dynamic weights, wherein the set of dynamic weights are based upon a number of executables found in each of a plurality of file system directories that are searched; and
said searching comprising searching said one or more file system directories utilizing an ordering indicated by said data structure,

9. The program product of claim 7, wherein said method further comprises:
in response to said operating system shell determining that said directory re-order option is not set, said operating system shell searching said one or more file system directories beginning with a file system directory containing a most recently located target binary executable.

10. The program product of claim 9, wherein said method further comprises:
recording a file system directory containing said target binary executable in an environmental variable of said operating system shell.

11. The program product of claim 7, wherein said determining comprises determining whether said directory re-order option is set by reference to an environmental variable of said operating system shell.

12. The program product of claim 7, wherein the method further comprises:
in response to locating said target executable, invoking execution of said target executable.

13. A data processing system, comprising:
a processor unit;
data storage coupled to said processor unit; and
an operating system shell within said data storage that causes the data processing system to perform a method including:
receiving a command identifying a target executable to be found;
in response to receiving the command, determining whether or not a directory re-order option is set;
in response to determining that said directory re-order option is set, locating the target executable by searching one or more file system directories for said for said target executable in accordance with an order indicated by a set of dynamic weights associated with directories among said one or more file system directories; and
updating the set of dynamic weights based upon the determined location of the target executable in the file system.

14. The data processing system of claim 13, wherein:
said method further comprises recording in a data structure the set of dynamic weights, wherein the set of dynamic weights are based upon a number of executables found in each of a plurality of file system directories that are searched; and
said searching comprising searching said one or more file system directories utilizing an ordering indicated by said data structure,

15. The data processing system of claim 13, wherein said method further comprises:
in response to said operating system shell determining that said directory re-order option is not set, said operating system shell searching said one or more file system directories beginning with a file system directory containing a most recently located target binary executable.

16. The data processing system of claim 15, wherein said method further comprises:
recording a file system directory containing said target binary executable in an environmental variable of said operating system shell.

17. The data processing system of claim 13, wherein said determining comprises determining whether said directory re-order option is set by reference to an environmental variable of said operating system shell.

18. The data processing system of claim 13, wherein the method further comprises:
in response to locating said target executable, invoking execution of said target executable.
